(19) United States
(12) Patent Application Publication
(10) Pub. No.: US 2004/0098271 A1
(43) Pub. Date: May 20, 2004

(54) Method and system for tracking the lifecycles of technology items

(75) Inventors: Jaye D. Hicks, Frisco, TX (US); Randall F. Mears, Plano, TX (US); Jeffrey L. Wacker, Plano, TX (US); Thomas L. Hill, Dallas, TX (US)

Correspondence Address: BAKER BOTTS L.L.P., 2001 ROSS AVENUE, SUITE 600, DALLAS, TX, 75201-2980, US

(73) Assignee: Electronic Data Systems Corporation

(21) Appl. No.: 10/294,170

(22) Filed: Nov. 14, 2002

(51) Int. Cl. G06F 17/60

(52) U.S. Cl. 705/1; 705/10

(57) ABSTRACT

According to one embodiment of the invention, a computerized method used by a company in tracking lifecycles of technology items includes receiving an identification of a technology item to track and receiving information from a plurality of sources regarding a plurality of characteristics of a lifecycle of the identified technology item in response to a query of the sources. The plurality of characteristics include a location within one of a plurality of segments of the lifecycle, a speed of movement of the technology item within its lifecycle, a disruptiveness of the technology item in the marketplace, and an engagement of technology item by the company. The computerized method further includes processing the received information and generating an output, in which the output includes a plurality of indicators representing the plurality of characteristics of the lifecycle.

### TECHNICAL FIELD OF THE INVENTION

The present invention relates generally to the field of tracking technology and, more particularly, to a method and system for tracking the lifecycles of technology items.

### BACKGROUND OF THE INVENTION

The technology industry moves fast and furiously. Numerous companies across the world offer products and services relating to the technology industry, such as hardware, software, and information technology services. When dealing with these products and services, various industry standards and/or processes may need to be followed. Because technology items, such as products, services, and standards are always emerging, advancing, and declining, it is important for a company to understand where a particular technology item is in its lifecycle. The more knowledge a company has about where a particular technology item is in its lifecycle, the better it can make educated decisions regarding the company's future involvement in that particular technology item, and the better they can use that knowledge to improve their bottom line as well as improving the relationships with customers, both existing and potential. For example, if a company knows that a particular technology item is about to become extinct, then the company can stop offering services related to that particular technology item.

Determining where a particular technology item is in its lifecycle is not an exact science. A company may have particular experts in particular areas of technology that may be able to present their opinion on where a particular technology item is in its lifecycle. And various industry experts may present their opinions in various forms of media, such as publications, newspapers, the Internet, and other media. However, such separate presentations may not suffice in determining where a particular technology item is in its lifecycle.

### SUMMARY OF THE INVENTION

According to one embodiment of the invention, a computerized method used by a company in tracking lifecycles of technology items includes receiving an identification of a technology item to track and receiving information from a plurality of sources regarding a plurality of characteristics of a lifecycle of the identified technology item in response to a query of the sources. The plurality of characteristics include a location within one of a plurality of segments of the lifecycle, a speed of movement of the technology item within its lifecycle, a disruptiveness of the technology item in the marketplace, and an engagement of technology item by the company. The computerized method further includes processing the received information and generating an output, in which the output includes a plurality of indicators representing the plurality of characteristics of the lifecycle.

Embodiments of the invention provide a number of technical advantages. Embodiments of the invention may include all, some, or none of these advantages. For example, the present invention may begin to track technology items when they first appear and may continue to track their progress until they reach the end of their lifecycle. Various characteristics of the lifecycle of a technology item may be tracked. For example, where a particular a technology item is in its lifecycle, how fast it is moving through its lifecycle, how disruptive the technology item is in the marketplace, and whether of not a company is involved with the technology item may be tracked. This tracking may allow a company to make educated decisions about a particular technology item, such as being able to predict the rise and fall of technology items so that the company can better allocate their energies and resources to focus on those technology items that may have the greatest strategic impact. Employees, such as marketing and/or sales people, that are not well versed in the maturity state of a technology item will be able to make decisions based on information obtained from internal and external experts, white papers, the press, technology analysts, and the state of the current company's portfolio. Being able to capture as much information as possible about a particular technology item and disseminating this information into a usable form may be beneficial to a company to get a “leg up” on the competition.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a conceptual block diagram illustrating a system of tracking the lifecycles of technology items according to one embodiment of the present invention;

FIG. 2 is a functional block diagram of the system of FIG. 1 according to one embodiment of the present invention;

FIG. 3 is a block diagram of a computer for use in carrying out one embodiment of the system of FIGS. 1 and 2;

FIG. 4 is a flowchart illustrating a method of tracking the lifecycles of technology items according to one embodiment of the present invention;

FIG. 5 is an exemplary output illustrating a plurality of lifecycle characteristics of a plurality of technology items in accordance with one embodiment of the present invention; and

FIG. 6 is an exemplary technology lifecycle graph for a particular technology item in accordance with one embodiment of the present invention.

### DETAILED DESCRIPTION OF EXAMPLE EMBODIMENTS OF THE INVENTION

Example embodiments of the present invention and their advantages are best understood by referring now to FIGS. 1 through 6 of the drawings, in which like numerals refer to like parts.

FIG. 1 is a conceptual block diagram of a system 100 used by an entity for tracking the lifecycles of technology items according to one embodiment of the present invention. A technology item as used herein may include hardware, software, technology standards, technology processes, technology services, or any combination thereof, however, other suitable technology items are also contemplated by the present invention.

In the illustrated embodiment, system 100 includes an information sources block 102, an information store block 104, and an interface block 106. Generally, information sources block 102 represents the obtaining of information from various sources regarding one or more characteristics of lifecycles of technology items, information store block 104 represents the processing and storing of the obtained information, and interface block 106 represents the viewing and utilization of the processed information stored at information store block 104. Tracking of various characteristics of the lifecycle of a technology item may allow an entity to make educated decisions about a particular technology item, such as being able to predict the rise and fall of technology items so that the entity can better allocate its resources to focus on those particular technology items that may have the greatest strategic impact for that entity.

Information sources block 102 may include a number of example information sources. In the illustrated embodiment, information sources block 102 includes an industry feed block 108, a corporate email block 110, a panel of experts block 112, a corporate portfolio block 114, a corporate repository block 116, and a votes block 118. Different information sources or a greater or lesser number of information sources are contemplated by the present invention.

Industry feed block 108 represents information obtained from the technology industry with respect to a particular technology item. This may include information from industry experts, such as consultants, academia, or other suitable experts that are knowledgeable about the particular technology item being tracked. This may also include information obtained from Internet websites or news groups. In one embodiment, the information obtained from the technology industry may be accomplished by text mining of reports, news articles, white papers, or other suitable electronic files stored in any suitable location. For example, the electronic files may be HTML or XML documents associated with web pages of a website. In other embodiments, industry experts may be queried to obtain the desired information about the technology item. In still other embodiments, experts within a particular company may be queried regarding a particular report or article from an industry expert so that the company experts can give their subjective opinion as to what that information means.

Corporate email block 110 represents information obtained from electronic mails sent between employees of a particular entity. This may include automated scanning of corporate email to obtain the internal corporate reputation surrounding a particular technology item.

Panels of experts block 112 represents information obtained from experts within a particular entity. Most technology companies have experts within their ranks that may be able to give educated opinions and information regarding a particular technology item. This information obtained from the experts may be received in any suitable manner, such as querying them with questionnaires by email or other suitable technique. A team of industry experts may also collaborate on a particular technology item and provide collective opinions.

Corporate portfolio block 114 represents information regarding current or potential products and/or services of a particular entity. For example, a technology services company may have a myriad of service offerings or ones that are in development. This information may be desired when tracking a particular technology item. In addition, an entity may have made, or maybe intending to make, specific capital investments relating to a particular technology item.

Corporate repository block 116 represents information obtained from electronic files stored either on servers or PCs of employees of an entity. This may also include the information obtained from a corporate website, for example. In other words, an employee of an entity may post a short article or other publication on the corporate web site and information from that article may be obtained in any suitable manner.

Votes block 118 represents information obtained as a result of feedback of the users associated with interface block 106. For example, once one or more lifecycles of technology items are tracked, this information may be viewed by a user and that user may give feedback on a particular technology item. Other suitable feedback may also be given, such as additional technology items that may need to be tracked or particular technology items that need to be grouped together.

In the illustrated embodiment, information store block 104 includes a current block 120, a historical block 122, and a reporting block 124. Different functional blocks or a greater or lesser number of functional blocks associated with information store block 104 are contemplated by the present invention.

Current block 120 represents information received from information sources block 102 that is stored. This information is current, as opposed to historical or future. For example, current block 120 may contain information on a particular taxonomy of technology items. This taxonomy may vary depending on the particular entity that is tracking the lifecycle of technology items. Current block 120 may contain information on the source of the information. Current block 120 may also contain the “scores” that were obtained as a result of the information received from information sources block 102, such as scores relating particular characteristics of various technology items. Scoring is discussed in greater detail below. Current block 120 may also contain points of contact within a particular entity, such as the identity of experts in a particular technology item.

Historical block 122 represents stored historical information on the lifecycles of particular technology items. Because the lifecycles of technology items are being tracked according to the teachings of the present invention, there is a history of a particular technology item, as represented by historical block 122. This historical information is stored so that it may be utilized by an employee of an entity who may wish to see how a particular technology item has moved over the last year or so. This is the type of information that is represented by historical block 122. Reporting block 124 represents recording information, such as audit trails.

In the illustrated embodiment, interface block 106 includes one or more viewing blocks 126, a taxonomy navigation block 128, a searching block 130, and a forecasting block 132. Different blocks or a greater or lesser number of blocks associated with interface block 106 are contemplated by the present invention.

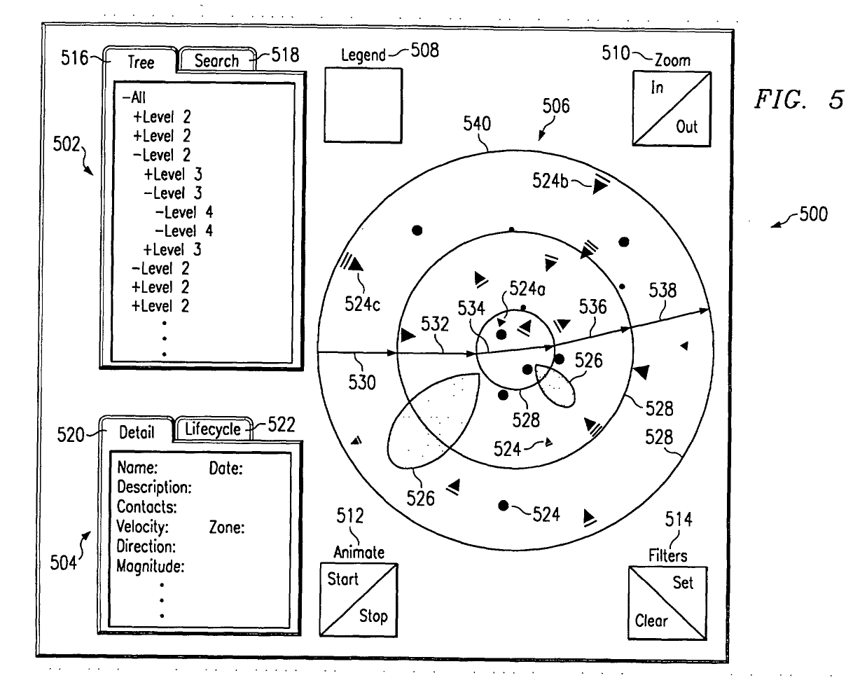

Viewing blocks 126 represent one or more outputs displaying the processed information related to the tracking of a lifecycle of a particular technology item. Two examples of such outputs are described below in conjunction with FIGS. 5 and 6. Generally, viewing blocks 126 allow a user to view and make particular decisions or form opinions about a particular technology item.

Taxonomy navigation block 128 allows a user to use a particular taxonomy of technology items to find technology items in an easy manner. Similarly, searching block 130 allows a particular user to run a search for a particular technology item. For example, the user may search using multiple search arguments, wild cards, and/or Boolean operators.

Forecasting block 132 allows a user to predict the lifecycle of a particular technology item by comparing it to another technology item from that other technology item's historical information. Other suitable forecasting may be accomplished, such as predicting the rise and/or fall of a particular technology item based on its own historical information.

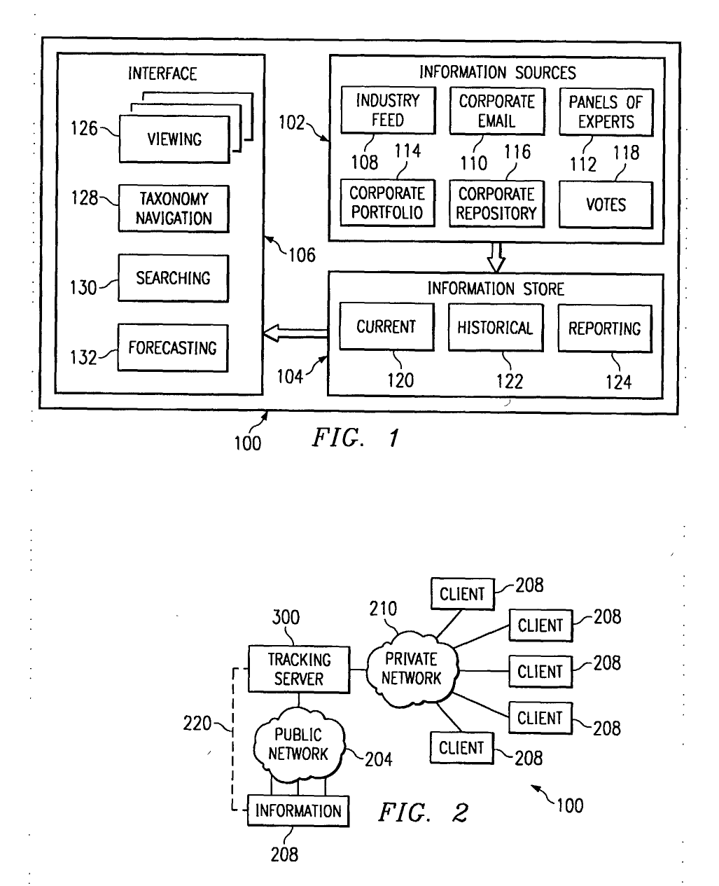

FIG. 2 is a functional block diagram of system 100 according to a simplified embodiment of the present invention. In the illustrated embodiment, system 100 includes an entity 202, a public network 204, and public information 206. Entity 202 is any suitable entity that desires to track the lifecycles of one or more technology items. For example, entity 202 may be a company that offers products and/or services to the technology industry. In the illustrated embodiment, entity 202 includes a tracking server 300 coupled to a plurality of clients 208 by a private network 210.

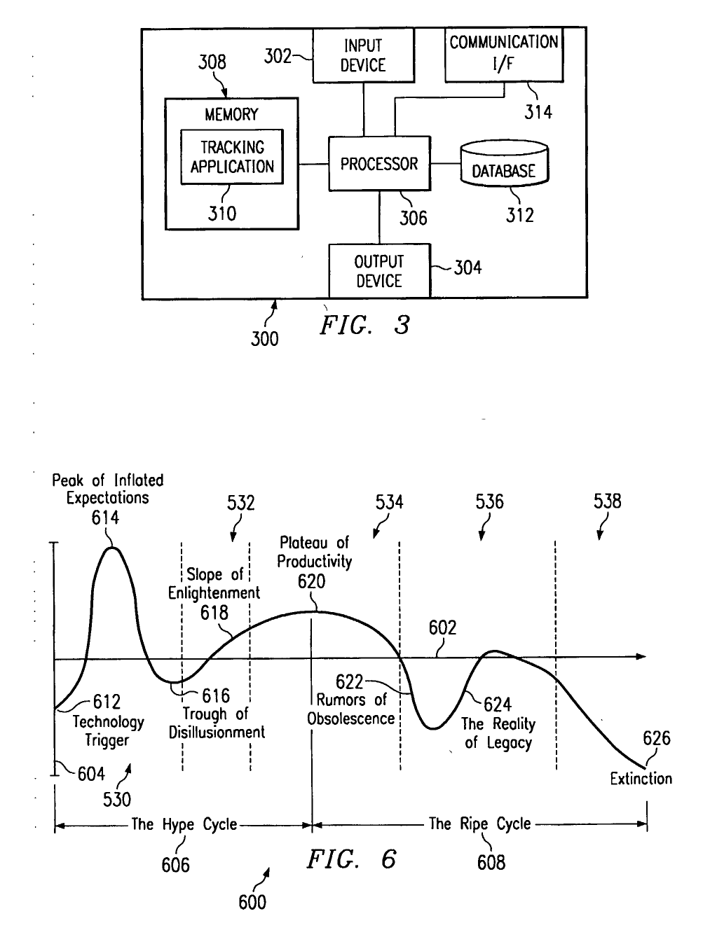

Tracking server 300, which is described in greater detail below in conjunction with FIG. 3, generally functions to receive information from various sources regarding the characteristics of the lifecycle of one or more technology items, process this received information, and store the processed information so that it may be utilized by one or more employees of entity 202. Tracking server 300 may be involved in both information sources block 102 and information store block 104 (FIG. 1). Although only one tracking server 300 is shown in FIG. 2, the functions carried out by tracking server 300 may be spread across multiple tracking servers 300 within entity 202.

Clients 208 may be any suitable computing devices that request information from tracking server 300. A particular client 208 may be associated with interface block 106 (FIG. 1). Clients 208 are coupled to tracking server 300 and to each other by private network 210, which may be a local area network, a wide area network, or any other suitable private network associated with entity 202. As an example, private network 210 may represent one or more intranets and/or extranets in one or more locations.

Public network 204 may be any suitable communications network, such as the Internet, that facilitates the transfer of information between information 206 and tracking server 300. In one embodiment, public network 204 uses a point-to-point tunneling protocol (“PPTP”) to communicate information between information 206 and tracking server 300. However, other suitable communications protocols may be utilized with public network 204 to transfer information from information 206 to tracking server 300.

Public information 206 represents any suitable public information that may be obtained by tracking server 300. Tracking server 300 may obtain this information via public network 204 or other suitable means, as denoted by dashed line 220. In one embodiment, public information includes a plurality of electronic files stored on one or more databases in one or more locations. However, public information 206 may include any suitable information stored in electronic form and stored in any suitable location, such as web servers, mainframes, personal computers, microcomputers, or any other suitable device that functions to store information electronically. Public information may also include information in hard copy form.

Referring to both FIG. 1 and FIG. 2, a brief operation of one embodiment of system 100 is now described. Entity 202 is a company that desires to track the lifecycles of one or more technology items. In order for entity 202 to track the lifecycles of technology items, entity 202 needs information regarding various characteristics of the technology items. This information is obtained from various sources, as depicted by information sources block 102 of FIG. 1. The information may be obtained from public information 206, clients 208, or other suitable source. Tracking server 300 may receive this information through public network 204, private network 210, or other suitable manner. After receiving the information, tracking server 300 processes it and stores it for later use. This processing and storing of the information is depicted by information store block 104 of FIG. 1. Once the information is stored, then an employee of entity 202 using a particular client 208 may access this stored information through private network 210. That employee may then view the information via one or more outputs generated by tracking server 300. Two such outputs are illustrated in FIGS. 5 and 6. The employee may view the lifecycle of a particular technology item by searching for that particular item or using a taxonomy navigation. The employee may then utilize the information in any suitable manner. For example, the employee may want to use the information as a selling tool for a perspective customer. Many other uses of the information are contemplated by the present invention.

FIG. 3 is a block diagram of tracking server 300 for use in carrying out one embodiment of system 100. Tracking server 300 includes an input device 302, an output device 304, a processor 306, a memory 308 storing tracking application 310, database 312, and communications interface 314.

Input device 302 is coupled to tracking server 300 for the purpose of inputting information, such as particular technology items desired to be tracked, a taxonomy for the particular technology items, or any other suitable information associated with the tracking of the lifecycles of technology items. In one embodiment, input device 302 is a keyboard; however, input device 302 may take other forms, such as a mouse, a stylus, or a scanner. Output device 304 may be any suitable visual display unit, such as an LCD or CRT display. Output device 304 may also be coupled to printer (not shown) for the purpose of printing out any desired information, such as outputs obtained as the result of the processed information stored within tracking server 300.

Processor 306 comprises any suitable processing unit that executes logic. One of the functions of processor 306 is to query a plurality of sources regarding one or more characteristics of a lifecycle of a technology item. For example, processor 306 may function to query a plurality of employees of entity 202 by private network 210 and clients 208. Processor 306 may also control the receiving and storing of that information in database 312 or other suitable storage location. Other suitable functions of processor 306 are contemplated by the present invention, such as retrieving and executing tracking application stored in memory 308.

Tracking application 310 is a computer program or a number of computer programs written in any suitable computer language that is operable, in one embodiment, to query a plurality of sources regarding one or more characteristics of a lifecycle of a technology item, receive information from the sources regarding the characteristics, process the information, store the information, and generate one or more outputs that present the information in a usable format. In the illustrated embodiment, tracking application 310 is logic encoded in memory 308. However, in alternative embodiments, targeted marketing application 310 is implemented through application specific integrated circuits (“ASICs”), field programmable gate arrays (“FPGAs”), digital signal processors (“DSPs”), or other suitable specific or general purpose processors.

Memory 308 and database 312 may comprise files, stacks, databases, or other suitable organizations of volatile or non-volatile memory. Memory 308 and database 312 may be random access memory, read only memory, CD-ROM, removable memory devices, or any other suitable devices that allow storage and/or retrieval of data. Memory 308 and database 312 are interchangeable and may perform the same functions.

Communications interface 314 functions to allow tracking server 300 to communicate with other devices in order to transmit and receive information. In one embodiment, communications interface 314 is a network interface card; however, communications interface 314 may be other devices suitable for receiving and transmitting signals, such as a modem or a digital subscriber line.

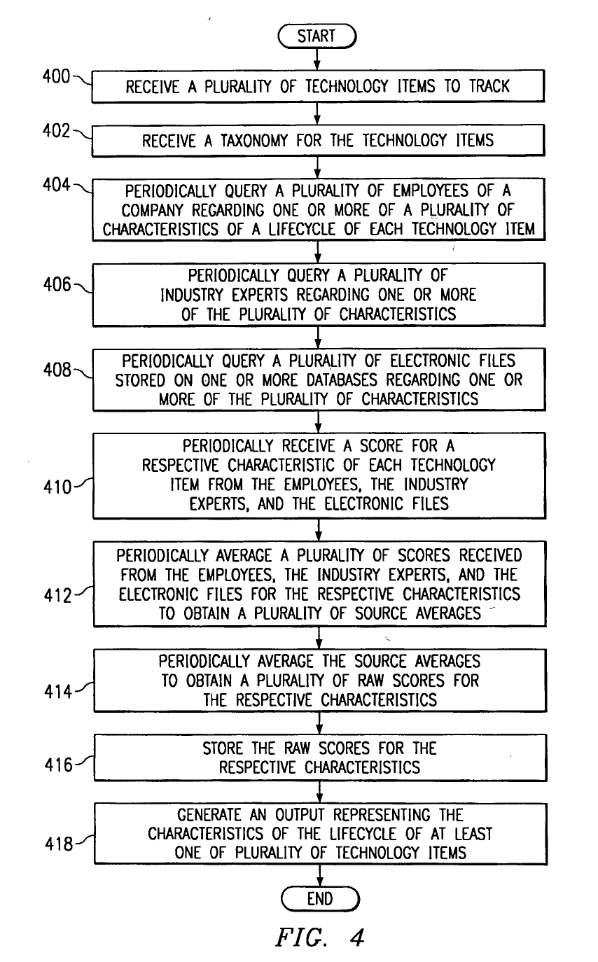

FIG. 4 is a flowchart illustrating a method of tracking the lifecycles of technology items according to one embodiment of the present invention. The steps outlined in FIG. 4 may be performed by tracking application 310 stored in memory 308 of tracking server 300. The method begins at step 400 where an identification of a plurality of technology items to track is received by tracking server 300. These technology items may be any items associated with any suitable type of hardware, software, standards, processes, and/or services. Tracking server 300 receives, at step 402, a taxonomy for the technology items. The taxonomy allows users associated with clients 208 (FIG. 2) to easily find the information on the particular technology item they are interested in. Any suitable taxonomy may be utilized.

To obtain the desired information on the technology items, tracking server 300 periodically queries a plurality of sources. As used herein, periodic means recurring from time to time whether at regular or irregular intervals. At step 404, tracking server 300 periodically queries a plurality of employees of entity 202 regarding one or more of a plurality of characteristics of a lifecycle of each of the technology items. In one embodiment, the characteristics of the lifecycle of a technology item include a location within one of a plurality of segments of the lifecycle, a speed of movement of the technology item within its lifecycle, a disruptiveness of the technology item in the marketplace, and an engagement of the technology item by entity 202. Each of these characteristics are described in further detail below in conjunction with FIG. 5. Other suitable characteristics may be utilized. A plurality of industry experts may also be periodically queried, at step 406, regarding one or more of the plurality of characteristics. In addition, a plurality of electronic files stored on one or more databases may be periodically queried, at step 408, regarding one or more of the plurality of characteristics.

At step 410, a “score” for a respective characteristic of each technology item is periodically received from the employees, the industry experts, and the electronic files. Scoring for a respective characteristic of a technology item is described in further detail below in conjunction with FIG. 5. The scores received from the industry experts may be received indirectly through experts of entity 202 after reviewing publications or other information produced by the industry experts. In addition, the scores received from the electronic files stored in the databases may be extracted based on some predetermined criteria set up by entity 202. In any event, the plurality of scores received from the employees, the industry experts, and the electronic files for the respective characteristics are periodically averaged, at step 412, to obtain a plurality of source averages. These source averages are periodically averaged, at step 414, to obtain a plurality of raw scores for each of the respective characteristics. The raw scores for the respective characteristics are stored at step 416 before one or more outputs representing the characteristics of the lifecycle of at least one of the plurality of technology items is generated at step 418. Two such outputs are illustrated below in conjunction with FIGS. 5 and 6. This ends one method using tracking lifecycles of technology items according to one embodiment of the present invention.

FIG. 5 is an exemplary output 500 illustrating a plurality of lifecycle characteristics of a plurality of technology items in accordance with one embodiment of the present invention. Output 500 is one example of what a user of client 208 of entity 202 may see on his or her output device 304. In the illustrated embodiment, output 500 includes a navigation section 502, a detail/lifecycle section 504, a radar graph 506, a legend section 508, a zoom section 510, an animate section 512, and a filters section 514. Output 500 may have different, more, or less elements depending on how tracking application 310 is set up by entity 202.

Navigation section 502, in the illustrated embodiment, includes a tree tab 516 and a search tab 518. Tree tab 516 may contain a taxonomy for the technology items that have been tracked. Any suitable taxonomy may be utilized. The taxonomy is typically a subjective evaluation of how the technology items should be organized. A user may use this taxonomy to find the desired technology item or group of technology items. Search tab 518 may be utilized by the user to search for a particular technology item by a keyword or other suitable type of search.

Detail/lifecycle section 504, in the illustrated embodiment, includes a detail tab 520 and a lifecycle tab 522. Detail tab 520 displays information regarding a particular technology item that is selected by a user. For example, as illustrated, detail tab 520 may include the name of the technology item, a short description of the technology item, contacts within entity 202 that have particular expertise with that technology item, and one or more characteristics of the technology item, such as the velocity, direction, and magnitude of the technology item. The characteristics of a particular technology item are described in further detail below. Lifecycle tab 522 displays information on the lifecycle for a particular technology item. An example lifecycle technology item is shown and described in further detail below in conjunction with FIG. 6.

Radar graph 506 is one particularly advantageous example graph illustrating the tracking of the lifecycles of a plurality of technology items. Radar graph 506 includes a plurality of taxonomy leaf indicators 524 and a plurality of taxonomy blobs 526. Radar graph 506 also includes a plurality of location rings 528. Generally, radar graph 506 graphically represents where a particular technology item is in its lifecycle. Where a particular technology is in its lifecycle depends on the “score” it receives through the information obtained from the various sources as described above. In other words, the information received from the employees of entity 202, the industry experts, and whether or not entity 202 is engaged in that particular technology item determines a raw score for a particular technology item that is utilized to graph that particular technology item on radar graph 506. Any suitable method of scoring may be utilized. In one embodiment, there are four scoring categories. They are a location within one of a plurality of segments of the lifecycle, a speed of movement of the technology movement within its lifecycle, a disruptiveness of the technology item in the marketplace, and an engagement of the technology item by entity 202.

The location of a technology item is typically determined by a subjective evaluation of where the technology item is in its lifecycle. However, the location may also be determined by an algorithm. The lifecycle of a particular technology item may be characterized in any suitable manner. In one embodiment, the lifecycle of a particular technology item includes an emerging segment 530, an adoption segment 532, a production segment 534, an avoidance segment 536, and an extinction segment 538. As noted on radar graph 506, emerging segment 530 and adoption segment 532 are both represented by arrows moving in towards production segment 534. Avoidance segment 536 and extinction segment 538 are represented by arrows moving away from production segment 534. In other words, as a particular technology item moves through its lifecycle it starts at outer ring 540 and moves through emerging segment 530, adoption segment 532, and into production segment 534 before moving back through avoidance segment 536 and extinction segment 538. Any suitable number and characterization of segments may be utilized to define a lifecycle for a particular technology item.

An example score given for a location of a particular technology item within its lifecycle may be from −100 to +100, with −100 representing a technology item at outer ring 540 moving inwardly (i.e., a technology item that has just emerged), zero representing the middle of production segment 534, and +100 representing a technology item at outer ring 540 moving outwardly (i.e., a technology item that is about to be extinct). An example is taxonomy leaf indicator 524a, which has a location score of about +15, as indicated by the arrow head pointing outwardly. Any suitable scoring system may be utilized for the location within radar graph 506.

A speed of movement of a technology item within its lifecycle represents how fast a particular technology item is moving through its lifecycle. This may be scored in any suitable manner. In one embodiment, a simple scoring system of zero, one, and two may be given depending on how fast the particular technology item is moving through its lifecycle. A “zero” score would mean that it is moving slowly, a “one” score would mean that it is moving at a medium pace, and a “two” score would mean that it is moving at a very fast pace. The speed of a particular technology item may be represented on radar graph 506 in any suitable manner. In one embodiment, the length of the tails of taxonomy leaf indicators 524 determine its speed. For example, taxonomy leaf indicator 524a has no tails on its arrowhead, which means it has been given a zero speed score. On the other hand, taxonomy leaf indicator 524b has one tail which means that it is moving at a medium pace and taxonomy leaf indicator 524c has two tails which means that it is moving at a very rapid pace.

A disruptiveness of the technology item in the marketplace may be represented on radar graph 506 in any suitable manner. In one embodiment, disruptiveness is defined as any technology that overturns a traditional business model. For example, the Internet was a disruptive technology item in the age of paper publishing. This definition was coined by Clayton Christensen of Harvard Business School. In one embodiment, the disruptiveness of a particular technology item is given a score of either zero, one, or two, as in the case of the speed. A very small taxonomy leaf indicator 524 would indicate a zero score meaning that it is not very disruptive, a medium-sized taxonomy leaf indicator 524 would indicate a somewhat disruptive technology item, and a very large taxonomy leaf indicator 524 would indicate a very disruptive technology item. Other suitable ways of displaying the disruptiveness of a particular technology item may be utilized with radar graph 506.

An engagement of a technology item by entity 202 may be scored in any suitable manner. In one embodiment, a zero, one, and two scoring system is utilized. A zero score would indicate that entity 202 is not currently engaged in that particular technology item, a one score means that the company is doing something with that particular technology item, and a two score would mean that entity 202 is fully engaged with that particular technology item. The engagement of entity 202 in a particular technology item may be represented on radar graph 506 in any suitable manner. In one embodiment, color is used to indicate the engagement. For example, a red color may mean that the corporation is not exerting any energy in the technology item, a blue color may mean that entity 202 is engaged at some level in the technology item, and green may mean that it is fully engaged in the technology item.

Taxonomy blobs 526 represent the dispersion of a number of taxonomy leaf indicators 524 that are related in some manner. This manner is determined by the taxonomy. If a user clicks on a particular taxonomy blob 526 then each of taxonomy blobs' associated taxonomy leaf indicators 524 are displayed.

Legend section 508 may display the particular legend for the visual display of technology items associated with radar graph 506. Zoom section 510 may allow a user to zoom into a particular segment. Other suitable zoom functions are contemplated by the present invention. Filter section 514 may function to provide any suitable filtering function. For example, using filter section 514 a user may be allowed to display only those technology items that are fully engaged in by entity 202 or to suppress technology items that are either declining or advancing. Other suitable filters are contemplated by the present invention. Animate section 512 may be used to animate radar graph 506 using a start date and an end date for a particular technology item. Other suitable animation functions are contemplated by the present invention.

FIG. 6 is an exemplary technology lifecycle 600 for a particular technology item in accordance with one embodiment of the present invention. Lifecycle 600 includes an x-axis 602 and a y-axis 604. X-axis 602 represents time and y-axis 604 represents the “popularity” of the particular technology item. Based on historical data, a typical technology item emerges, as denoted on lifecycle 600 by a technology trigger 612, and quickly rises on the popularity scale until reaching a peak of inflated expectations 614. The quick rise is due to the initial “buzz” surrounding the technology item (i.e., people think it's the best thing since sliced bread). The initial buzz wears off fairly quickly until the technology item reaches a trough of disillusionment 616. The technology item then starts being adopted by more and more people as it rises through a slope of enlightenment 618 until reaching a plateau of productivity 620, in which many people are utilizing the technology item. At this point, the technology item is in the mainstream. After a certain while use of the technology item starts to decline in popularity as it becomes outdated or irrelevant; this is indicated by a rumors of obsolescence 622. It's popularity briefly picks back up, as denoted by a reality of legacy 624 before slowly declining in popularity before an extinction point 626. Again, this is only one example of a lifecycle of a technology item; other suitable lifecycles may be utilized within the spirit and scope of the present invention.

To illustrate the correlation between lifecycle 600 and radar graph 506 (FIG. 5), lifecycle 600 also generally illustrates emerging section 530, adoption segment 532, production segment 534, avoidance segment 536, and extinction segment 538. As described above, any suitable number and characterization of segments of lifecycle 600 may be utilized. Lifecycle 600 also may be broken down into a hype cycle 606 and a ripe cycle 608. Hype cycle 606 is well known in the art and it essentially tracks a technology item only to plateau of productivity 620. Hype cycle 606 was developed by the Gartner Group. The present invention extends hype cycle 606 into ripe cycle 608, which fully tracks a technology item throughout its whole lifecycle from technology trigger 612 to extinction 626.

Although embodiments of the invention and their advantages are described in detail, a person skilled in the art could make various alterations, additions, and omissions without departing from the spirit and scope of the present invention as defined by the appended claims.

What is claimed is:

1. A computerized method used by a company in tracking lifecycles of technology items, comprising:
receiving an identification of a technology item to track;
receiving information from a plurality of sources regarding a plurality of characteristics of a lifecycle of the identified technology item in response to a query of the sources, the plurality of characteristics comprising:
a location within one of a plurality of segments of the lifecycle;
a speed of movement of the technology item within its lifecycle;
a disruptiveness of the technology item in the marketplace; and
an engagement of technology item by the company;
processing the received information; and
generating an output, the output having a plurality of indicators representing the plurality of characteristics of the lifecycle.

2. The computerized method of claim 1, further comprising periodically repeating the receiving information, processing, and generating steps.

3. The computerized method of claim 1, wherein receiving the identification of the technology item to track comprises:
receiving an identification of a plurality of technology items to track; and
receiving a taxonomy for the identified technology items.

4. The computerized method of claim 1, wherein the technology item is selected from the group consisting of hardware, software, standards, processes, and services.

5. The computerized method of claim 1, wherein the plurality of sources comprises a plurality of employees of the company, a plurality of industry experts, and a plurality of electronic files stored on one or more databases.

6. The computerized method of claim 1, wherein the plurality of segments of the lifecycle of the technology item comprises an emerging segment, an adoption segment, a production segment, an avoidance segment, and an extinction segment.

7. The computerized method of claim 1, wherein receiving information from the sources comprises receiving a score for at least one of the plurality of characteristics of the technology item.

8. The computerized method of claim 1, wherein processing the information comprises:
averaging a plurality of scores received from each source regarding a respective characteristic to obtain a plurality of source averages; and
averaging the source averages to obtain a raw score for the respective characteristic.

9. The computerized method of claim 8, further comprising weighting the scores received from each source.

10. The computerized method of claim 1, wherein the output comprises a radar graph.

11. The computerized method of claim 1, further comprising predicting a future characteristic of a different technology item based on a tracking history of the technology item.

12. A computerized method used in tracking lifecycles of technology items, comprising:
receiving an identification of a plurality of technology items to track;
receiving a taxonomy for the identified technology items;
periodically querying a plurality of employees of a company regarding a plurality of characteristics of a lifecycle of each technology item, the plurality of characteristics comprising:
a location within one of a plurality of segments of the lifecycle;
a speed of movement of the technology item within its lifecycle;
a disruptiveness of the technology item in the marketplace; and
an engagement of technology item by the company;
periodically querying a plurality of industry experts regarding the plurality of characteristics;
periodically querying a plurality of electronic files stored on one or more databases regarding the plurality of characteristics;
periodically receiving a score from the employees, the industry experts, and the electronic files regarding respective characteristics of each technology item;
periodically averaging the scores received from the employees, the industry experts, and the electronic files for the respective characteristics to obtain a plurality of source averages;
periodically averaging the source averages to obtain a plurality of raw scores for the respective characteristics;
storing the raw scores for the respective characteristics; and
generating an output representing the raw scores for the respective characteristics of the lifecycle of at least one of the plurality of technology items.

13. The computerized method of claim 12, wherein each technology item is selected from the group consisting of hardware, software, standards, processes, and services.

14. The computerized method of claim 12, wherein the lifecycle of each technology item comprises an emerging segment, an adoption segment, a production segment, an avoidance segment, and an extinction segment.

15. The computerized method of claim 12, further comprising weighting the scores received from the employees, the industry experts, and the electronic files.

16. The computerized method of claim 12, further comprising predicting a future characteristic of one of the technology items based on a tracking history of another technology item.

17. A computerized method used by a company in tracking lifecycles of technology items, comprising:
receiving an identification of a technology item to track;
receiving a plurality of scores from a plurality of sources regarding a plurality of characteristics of a lifecycle of the identified technology item in response to a query of the sources, the plurality of characteristics comprising:
a location within one of a plurality of segments of the lifecycle;
a speed of movement of the technology item within its lifecycle;
a disruptiveness of the technology item in the marketplace; and
an engagement of technology item by the company;
averaging the scores received from each source regarding a respective characteristic to obtain a plurality of source averages;
averaging the source averages to obtain a raw score for the respective characteristic; and
generating an output representing the raw scores for the plurality of characteristics of the lifecycle of the identified technology item.

18. The computerized method of claim 17, further comprising periodically repeating the receiving the plurality of scores, averaging, and generating steps.

19. The computerized method of claim 17, wherein receiving the identification of the technology item to track comprises:
receiving an identification of a plurality of technology items to track; and
receiving a taxonomy for the identified technology items.

20. The computerized method of claim 17, wherein the technology item is selected from the group consisting of hardware, software, standards, processes, and services.

21. The computerized method of claim 17, wherein the plurality of sources comprises a plurality of employees of a company, a plurality of industry experts, and a plurality of electronic files stored on one or more databases.

22. The computerized method of claim 17, wherein the plurality of segments of the lifecycle of the technology item comprises an emerging segment, an adoption segment, a production segment, an avoidance segment, and an extinction segment.

23. The computerized method of claim 17, further comprising weighting the scores received from each source.

24. The computerized method of claim 17, wherein generating an output comprises generating a radar graph.

25. The computerized method of claim 17, further comprising predicting a future characteristic of a different technology item based on a tracking history of the technology item.

26. Logic encoded in media for use by a company in tracking lifecycles of technology items, the logic operable to perform the following steps:
receive an identification of a technology item to track;
receive a plurality of scores from a plurality of sources regarding a plurality of characteristics of a lifecycle of the identified technology item in response to a query of the sources, the plurality of characteristics comprising:
a location within one of a plurality of segments of the lifecycle;
a speed of movement of the technology item within its lifecycle;
a disruptiveness of the technology item in the marketplace; and
an engagement of technology item by the company;
average the scores received from each source regarding a respective characteristic to obtain a plurality of source averages;
average the source averages to obtain a raw score for the respective characteristic; and
generate an output representing the raw scores for the plurality of characteristics of the lifecycle of the identified technology item.

27. The logic encoded in media of claim 26, the logic further operable to periodically repeat the receive the plurality of scores, average, and generate steps.

28. The logic encoded in media of claim 26, the logic further operable to:
receive an identification of a plurality of technology items to track; and
receive a taxonomy for the identified technology items.

29. The logic encoded in media of claim 26, wherein the technology item is selected from the group consisting of hardware, software, standards, processes, and services.

30. The logic encoded in media of claim 26, wherein the plurality of sources comprises a plurality of employees of a company, a plurality of industry experts, and a plurality of electronic files stored on one or more databases.

31. The logic encoded in media of claim 26, wherein the plurality of segments of the lifecycle of the technology item comprises an emerging segment, an adoption segment, a production segment, an avoidance segment, and an extinction segment.

32. The logic encoded in media of claim 26, the logic further operable to weight the scores received from each source.

33. The logic encoded in media of claim 26, the logic further operable to generate a radar graph representing the raw scores for the plurality of characteristics of the lifecycle of the identified technology item.

34. The logic encoded in media of claim 26, the logic further operable to predict a future characteristic of a different technology item based on a tracking history of the technology item.
